(19) United States
(12) Patent Application Publication
(10) Pub. No.: US 2026/0178958 A1
(43) Pub. Date: Jun. 25, 2026

(54) NEURAL NETWORK REPRESENTATION OF QUANTUM CIRCUITS

(71) Applicant: Fujitsu Limited, Kawasaki-shi (JP)

(72) Inventors: Bibhas ADHIKARI, San Jose, CA (US); Xiaoyuan LIU, Santa Clara, CA (US)

(73) Assignee: Fujitsu Limited, Kawasaki-shi (JP)

(21) Appl. No.: 19/001,335

(22) Filed: Dec. 24, 2024

(51) Int. Cl. G06N 10/60; G06N 10/20

(52) U.S. Cl. CPC G06N 10/60; G06N 10/20

(57) ABSTRACT

A method may include obtaining a configuration of a quantum circuit comprising n qubits and k quantum gates. The k quantum gates include at least a single-qubit gate or a two-qubit control gate. The method may include constructing a neural network representing the quantum circuit, wherein the neural network includes k+1 layers that include k pairs of adjacent layers, with each pair of the adjacent layers corresponding to one of the k quantum gates. The method may include connecting one or more nodes in each pair of the adjacent layers based on a representation of a corresponding quantum gate of the k quantum gates. The method may include training the neural network using machine learning techniques to obtain an output. The method may include applying the output to the quantum circuit.

### FIELD

The present disclosure generally relates to neural network representation of quantum circuits.

### BACKGROUND

Quantum computers may use quantum bits (“qubits”) capable of representing information as ones, zeroes, or ones and zeroes simultaneously on quantum gates to perform quantum computing operations. Quantum computers may train parameters of quantum computing system models to more efficiently and/or more accurately perform some types of quantum computing operations (e.g., optimizations, graph partitioning, quadratic programming, etc.) than classical computers.

The subject matter claimed in the present disclosure is not limited to embodiments that solve any disadvantages or that operate only in environments such as those described above. Rather, this background is only provided to illustrate example technology areas where some embodiments described in the present disclosure may be practiced.

### SUMMARY

According to an aspect of an embodiment, a method may include obtaining a configuration of a quantum circuit including n qubits and k quantum gates. The k quantum gates include at least one of a single-qubit gate or a two-qubit control gate. A neural network representing the quantum circuit may be constructed. The neural network includes k+1 layers that include k pairs of adjacent layers, with each pair of the adjacent layers corresponding to one of the k quantum gates. One or more nodes in each pair of the adjacent layers may be connected based on a representation of a corresponding quantum gate of the k quantum gates. The neural network may be trained using machine learning techniques to obtain an output. The output may be applied to the quantum circuit.

The objects and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example environment related to training quantum computing system model parameters.

FIG. 2 illustrates a block diagram of an example computing system.

FIG. 3 illustrates an example quantum circuit in a three-qubit system.

FIG. 4A illustrates a topological pattern in a neural network architecture, such as a linear neural network, used to represent a single-qubit gate.

FIG. 4B illustrates a topological pattern in a neural network architecture used to represent a two-qubit control gate.

FIG. 4C illustrates another topological pattern in a neural network architecture used to represent a two-qubit control gate.

FIG. 5A illustrates an example quantum circuit.

FIG. 5B illustrates an example neural network configured to represent a quantum circuit.

FIG. 6 is a flowchart of an example method of training quantum computing systems using neural network representation of quantum circuits.

FIG. 7 is a flowchart of another example method of training quantum computing systems using neural network representation of quantum circuits.

### DETAILED DESCRIPTION

Quantum computers use quantum bits, or “qubits,” which may be configured to store values of 0, 1, or a superposition of both 0 and 1. Since qubits are capable of simultaneously storing multiple values/existing in multiple states, quantum computers may be capable of performing calculations more quickly and/or more accurately than classical computers that only use classical bits capable of storing values of either 0 or 1. As a result, quantum computers may more efficiently train quantum computing system models related to advanced computations and/or may improve computations in various technology fields such as physics, chemistry, finance, and machine learning (ML).

Quantum circuits are designed to perform specific tasks that generate desired outputs, which enables quantum computing systems to address real-world problems. For example, a quantum circuit may be used to solve optimization problems, such as selecting a portfolio of stocks to achieve a target gain. Traditionally, achieving a desired output involves proposing and testing multiple quantum circuits to identify the most effective solution. This process, however, requires substantial quantum resources, as each proposed circuit is implemented on quantum hardware for evaluation. As such, resources expended on unselected circuits may be effectively wasted. This process may result in inefficiencies in the quantum circuit design process.

Systems and/or method are described that may assist in improving quantum circuit evaluation and implementation, which may help to overcome the inefficiencies described above. The systems and/or method described in the present disclosure recognize that a quantum circuit, such as a parameterized quantum circuit (PQC), may be similar in some respects to a machine learning model. As a result, a classical neural network may be used to represent a proposed quantum circuit. For example, layers of the neural network may represent quantum gates within a quantum circuit. Based on this representation, the classical neural network may be trained on a classical computer with machine learning algorithms. After the neural network is trained, the trained configuration of the neural network may be applied back to determine a configuration of the quantum circuit. This approach helps to enable efficient evaluation and optimization of quantum circuits and may reduce wasting quantum resources.

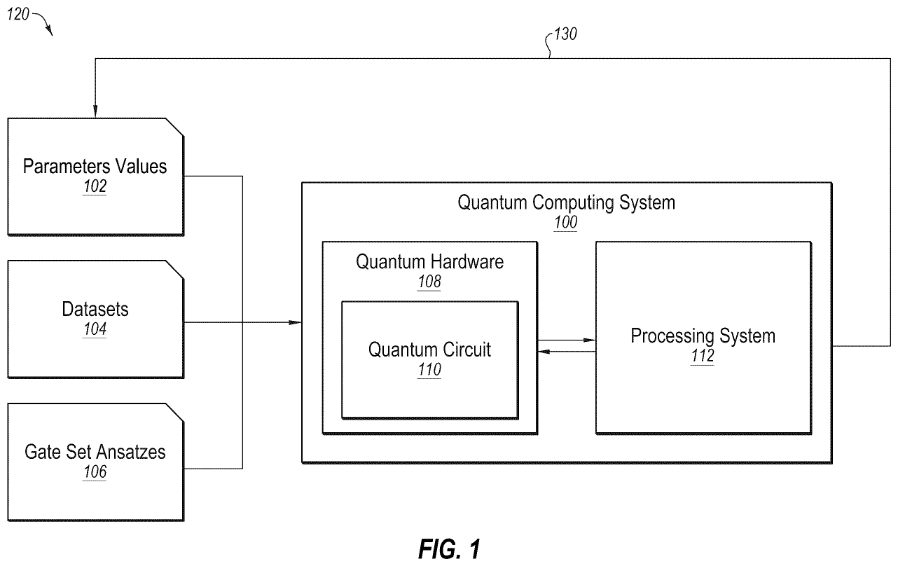

Embodiments of the present disclosure are explained with reference to the accompanying figures. FIG. 1 illustrates an example environment 120 related to training quantum computing system model parameters according to one or more embodiments of the present disclosure. The environment 120 may include a quantum computing system 100, parameter values 102, datasets 104, and gate set ansatzes 106. The quantum computing system 100 may be configured to take the parameter values 102, the datasets 104, the gate set ansatzes 106 as inputs and to update one or more of the parameter values 102 with specific trained values.

In some embodiments, the quantum computing system 100 may include quantum hardware 108. For example, the quantum hardware 108 may include a quantum processor that includes one or more qubits and an ability to store the qubits. In some embodiments, the qubits may be physically implemented using, for example, photons, trapped ions, electrons, one or more nuclei, superconductor circuits, and/or quantum dots. For example, the qubits may be physically implemented in a variety of ways including the polarization state of a single photon, the spatial optical path of a single photon, two differing energy states of an atom or an ion, and/or the spin orientation of a particle or multiple particles, such as a nucleus. In some embodiments, the quantum processor may include at least two qubits and at least one coupler capable of coupling the qubits. Storing the qubits may include maintaining the qubits in a suitable environment to allow quantum computation, for example by supercooling the qubits.

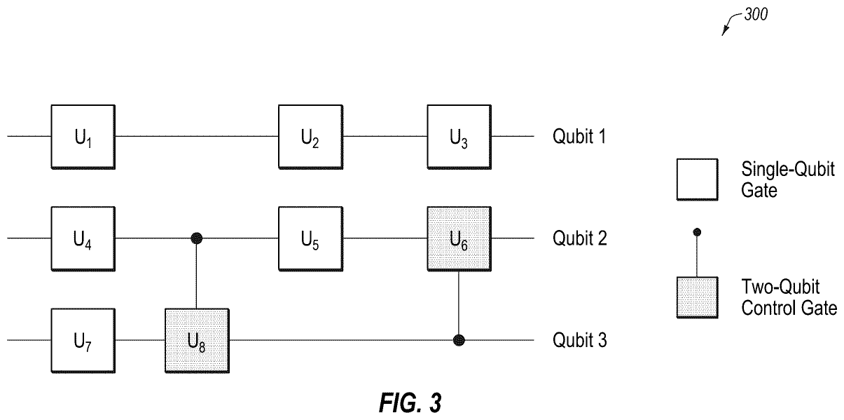

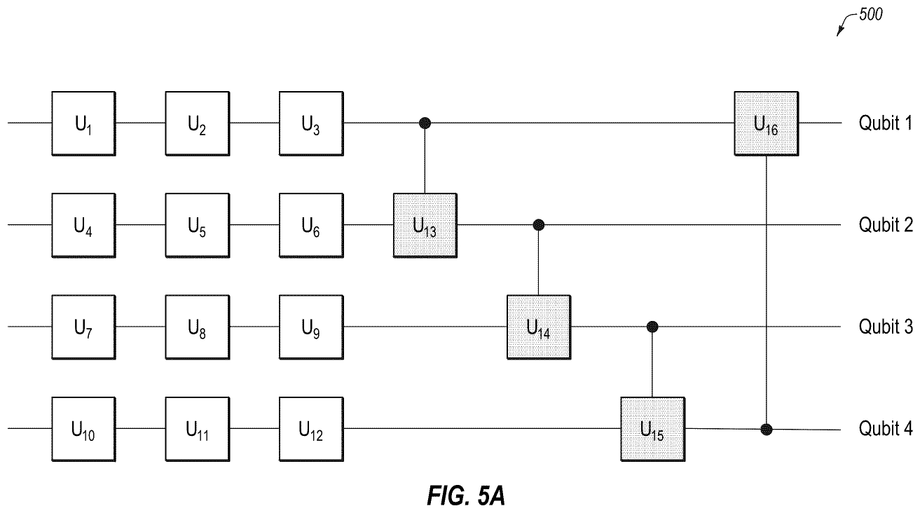

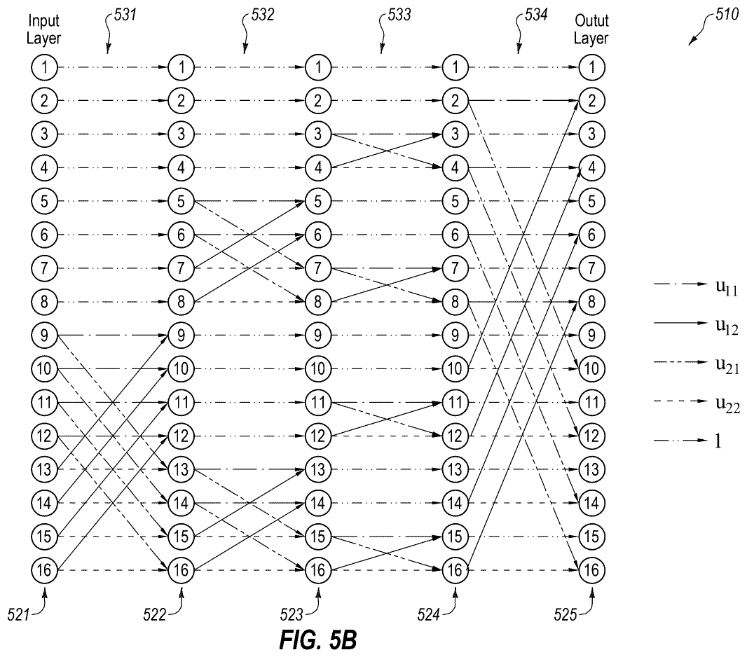

In some embodiments, the quantum hardware 108 may include a quantum circuit 110. The quantum circuit 110 may be formed by a suitable arrangement of quantum gates and may operate on the qubits included in the quantum hardware 108. The quantum circuit 110 may determine properties of electromagnetic waves that may be applied to the qubits of the quantum hardware 108 to adjust the states of the qubits. The quantum circuits 300 and 500, described in FIGS. 3 and 5A, respectively, may be examples of the quantum circuit 110.

In general, a quantum computing system such as the quantum computing system 100 may operate to perform quantum computations using a series of quantum gates that operate on quantum bits, e.g., qubits, of the quantum computing system. In general, quantum gates are configured to manipulate the quantum states of qubits. The quantum states of a qubit may include a basic state, a superposition state that may be represented by any point on a surface of a sphere where two opposite points on the sphere represent the basis states of 1 and 0 of the qubit, and a entangled state where the qubit state is based on the state of another qubit. The quantum states of the qubit may be adjusted. For example, a quantum gate may adjust the superposition state of the qubit by rotating the state of the qubit from a first position to a second position. In these and other embodiments, a quantum gate may represent an operation that may be performed on a qubit. As such, the quantum gate may be implemented by controlling the quantum hardware 108 that encodes qubits, such as by manipulating the energy levels of atoms, ions, photons, or superconducting circuits that form the quantum hardware. In these and other embodiments, the quantum hardware 108 may be controlled by application of electromagnetic waves, such as b laser, microwaves, or other electromagnetic waves.

In these and other embodiments, how a quantum gate adjusts a qubit may be determined based on the parameter values 102, which represent the values of parameters of the quantum gate. For example, a gate may be configured to adjust the superposition of a qubit. In this example, a parameter of the gate may indicate the operator to be applied by the gate to the qubit, such as an angle of rotation of the qubit. As another example, a gate may be configured to adjust the strength of entanglement of one qubit with another qubit. Thus, each of the quantum gates may have one or more separate parameters that may be adjusted. A symbolic unitary matrix U may be used to represent a single-qubit quantum gate, expressed by the following expression (1):

$$U = [ \begin{matrix}{u}_{11} & {u}_{12} \\ {u}_{21} & {u}_{22}\end{matrix} ] \qquad ( 1 )$$

where u₁₁, u₁₂, u₂₁, and u₂₂ represent separate parameters of the single-qubit quantum gate.

The different parameters of a quantum gate may be implemented by adjusting one or more property of an electromagnetic wave that is applied to the quantum hardware. For example, an amplitude, pulse shape, duration, wavelength, or phase or other property of an electromagnetic wave may be set at a particular setting to achieve a different parameter of a quantum gate. For example, to rotate a qubit around a particular idealized axis a particular amount, such as 45 degrees, a microwave pulse with a particular duration may be applied to the qubit. In these and other embodiments, other properties of the microwave pulse may be set at a particular setting to help achieve the correct adjustment of the qubit. Thus, to adjust a parameter of a quantum gate, a property of an electromagnetic wave that may be applied to quantum hardware may be adjusted.

The quantum gates may be organized in a specific manner to implement a quantum application. For example, a quantum application may be developed to perform a specific task to solve a real-world problem. For example, a task may be a quantum Fourier transform or optimization problem, such as how to select stocks to form a portfolio that achieves a desired gain and risk tolerance. The optimization problem may be encoded into a quantum algorithm. The quantum algorithm may be represented by a specific set of quantum gates organized in a specific manner that encodes variables and operations of the quantum algorithm into a sequence of quantum gates. A set of quantum gates organized in a specific sequence may be referred to as the gate set ansatzes 106.

The gate set ansatzes 106 may include quantum gates for solving the optimization problem. However, the quantum gate set ansatzes 106 may not include values for the parameters of the quantum gates in the quantum gate set ansatzes. Selection of a specific parameter value for each of the quantum gates in the quantum gate set ansatzes may be achieved by training of the parameters. Training of the parameters may include iteratively adjusting the parameters of the gates using optimization technique. Generally, before training, none of the parameter values 102 for the quantum gates may be known. As such, each of the parameter values 102 may be initialized at zero, random numbers, or some other selected values. During training, values from datasets 104 may be provided to the quantum gates and an outcome generated. The generated outcome may be compared to a known outcome for the values. Based on a difference between the generated outcome and the known outcome the parameter values 102 may be adjusted or updated, denoted by arrow 130. For example, the quantum computing system 100 may update one or more values of the parameter values 102 with specific trained values based on computation performed by the quantum computing system 100. Updating the parameter values 102 may result in one or more properties of the electromagnetic wavelengths applied to qubits of the quantum hardware 108 to generate the outcome being adjusted. For example, based on known gradient or gradient-free methods, the parameters may be updated to minimize or maximize a value computed from the generated outputs. Training may continue until the difference between the generated outcome and the known outcome are within a particular threshold or some other outcome results, such as a limit on a number of iterations or processing time.

The processing system 112 may be any configuration of non-quantum processing devices and/or system. For example, the processing system 112 may include one or more elements of the computing system 200. In these and other embodiments, the processing system 112 may be configured to control the quantum hardware 108, provide data to the quantum hardware 108, obtain data from the quantum hardware 108, and/or otherwise interact with the quantum hardware 108 to assist the quantum hardware 108 in performing the functionality of the quantum hardware 108. The processing system 112 may also be configured to train the parameter values for the quantum gates using neural networks, such as neural network 510 illustrated in FIG. 5B.

In some embodiments, the parameter values 102, the datasets 104, and/or the gate set ansatzes 106 may be obtained/provided to the quantum computing system 100 via one or more physical networks, cloud networks, Random Access Memory (RAM) drives, flash memory devices (e.g., solid state memory devices), and/or any other way by which data may be transferred between devices and/or systems.

An example of using the quantum computing system 100 to solve an optimization problem is now provided. The quantum circuit 110 may be designed and configured according to the gate set ansatzes 106 to solve a real-world problem such as an optimization problem. The processing system 112 may develop a neural network representation of the gate set ansatzes 106, according to one or more embodiments of this disclosure. The quantum computing system 100 may perform one or more operations to train the parameters of the gate set ansatzes 106 represented by the neural network. For example, the neural network that represents the gate set ansatz 106 may be trained. The resulting elements of the neural network, such as edge weighs or other aspects of the neural network may be used to select the parameters of one or more quantum gates of the gate set ansatz. In these and other embodiments, the quantum computing system 100 may update the parameter values 102 for the quantum gates with the specific trained values.

After selecting the parameters, data may be provided to the quantum hardware 108 and processed to generate an output. To process the data, the states of the qubits may be set using the electromagnetic waves with the specific properties. The output may be a solution for the optimization problem given the data provided to the quantum hardware 108.

Modifications, additions, or omissions may be made to the environment 120 without departing from the scope of the disclosure. For example, the quantum computing system 100 may include one or more additional components. Alternately or additionally, the quantum computing system 100 may not include the processing system 112. In these and other embodiments, the processing system 112 may be separate from and networked with the quantum computing system 100. Alternately or additionally, the environment 120 may include one or more additional components.

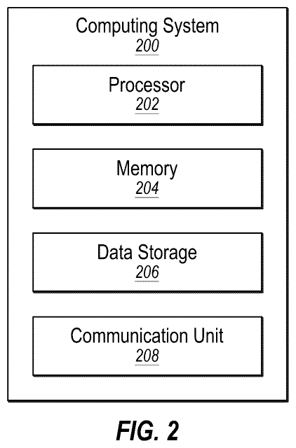

FIG. 2 illustrates a block diagram of an example computing system in accordance with one or more embodiments of the present disclosure. The computing system 200 may include a processor 202, a memory 204, a data storage 206, and/or a communication unit 208, which all may be communicatively coupled. For example, the processing system 112 of FIG. 1 may include one or more components of the computing system 200.

Generally, the processor 202 may include any suitable special-purpose or general-purpose computer, computing entity, or processing device including various computer hardware or software modules and may be configured to execute instructions stored on any applicable computer-readable storage media. For example, the processor 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor, it is understood that the processor 202 may include any number of processors distributed across any number of network or physical locations that are configured to perform individually or collectively any number of operations described in the present disclosure. In some embodiments, the processor 202 may interpret and/or execute program instructions and/or process data stored in the memory 204, the data storage 206, or the memory 204 and the data storage 206. In some embodiments, the processor 202 may fetch program instructions from the data storage 206 and load the program instructions into the memory 204.

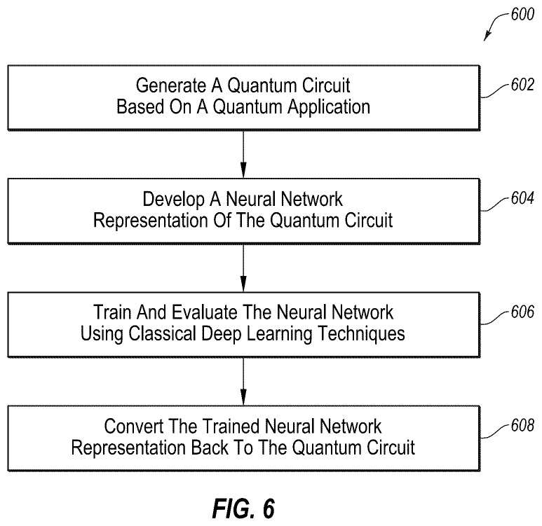

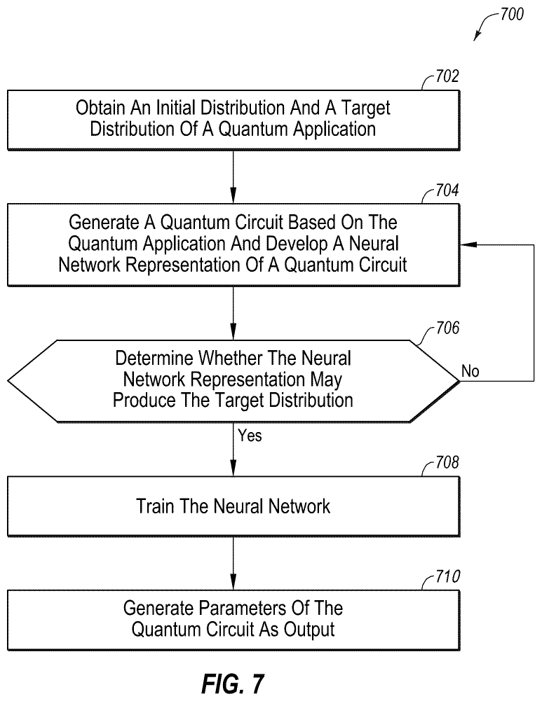

After the program instructions are loaded into the memory 204, the processor 202 may execute the program instructions, such as instructions to cause the computing system 200 to perform some of the operations of the methods 600 and 700 of FIGS. 6 and 7.

The memory 204 and the data storage 206 may include computer-readable storage media or one or more computer-readable storage mediums for having computer-executable instructions or data structures stored thereon. Such computer-readable storage media may be any available media that may be accessed by a general-purpose or special-purpose computer, such as the processor 202. In some embodiments, the computing system 200 may or may not include either of the memory 204 and the data storage 206.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a particular operation or group of operations.

The communication unit 208 may include any component, device, system, or combination thereof that is configured to transmit or receive information over a network. In some embodiments, the communication unit 208 may communicate with other devices at other locations, the same location, or even other components within the same system. For example, the communication unit 208 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 208 may permit data to be exchanged with a network and/or any other devices or systems described in the present disclosure. For example, the communication unit 208 may allow the computing system 200 to communicate with other systems, such as computing devices and/or other networks.

One skilled in the art, after reviewing this disclosure, may recognize that modifications, additions, or omissions may be made to the computing system 200 without departing from the scope of the present disclosure. For example, the computing system 200 may include more or fewer components than those explicitly illustrated and described.

FIG. 3 illustrates an example quantum circuit 300 in a three-qubit system according to one or more embodiments of the present disclosure. The quantum circuit 300 may be an example of the quantum circuit of FIG. 1. The quantum circuit 300 includes three qubits, denoted as qubit 1, qubit 2, and qubit 3. Qubit 1 is configured with three single-qubit gates, denoted as U₁, U₂, and U₃. In these and other embodiments, the single-qubit gates may adjust an angle of rotation of the qubit. Qubit 2 includes two single-qubit gates, denoted as U₄ and U₅, and a two-qubit control gate, denoted as U₆. For gate U₆, qubit 3 is the control qubit and qubit 2 is the target qubit. On qubit 3 there are a single-qubit gate U₇ and a two-qubit control gate U₈. For gate U₈, qubit 2 is the control qubit and qubit 3 is the target qubit. In these and other embodiments, the two-qubit control gate U₈ may be used to create entanglement between the control qubit and the target qubit. The parameters of the two-qubit control gate may be configured to adjust a strength of entanglement of the control qubit and the target qubit and/or other aspects of entanglement between the control qubit and the target qubit.

A quantum circuit may represent a unitary evolution through strings of single-qubit gates and two-qubit control gates for a given n-qubit initial state. In a paper Local Hamiltonian Decomposition and Classical Simulation of Parametrized Quantum Circuits, Adhikari et al., arXiv preprint arXiv: 2401.13156, 2024, (hereinafter, “Reference 1”), which is incorporated by reference herein in its entirety, unitary matrix representations for single-qubit gates and two-qubit control gates in a quantum circuit have been developed. These representations correspond to the canonical basis of n-qubit Hilbert space.

Let U be a symbolic unitary matrix, which represents a single-qubit gate. U may be expressed by the expression (1) described previously and reproduced below:

$$U = [ \begin{matrix}{u}_{11} & {u}_{12} \\ {u}_{21} & {u}_{22}\end{matrix} ] \qquad ( 1 )$$

Let Sⱼ denote the unitary matrix corresponding to a single-qubit gate U employed at the j-th qubit in an n-qubit system. Sⱼ has an order of 2ⁿ, which means that it is a square matrix with 2ⁿ rows and 2ⁿ columns. According to Reference 1, Sⱼ is a two-sparse matrix and may be expressed by a block-diagonal matrix with 2^{j-1} blocks in the following expression (2):

$${S}_{j} = diag \{ {\underbrace{\hat{U} , ……… \hat{U}}}_{{2}^{j - 1} times} \} \qquad ( 2 )$$

where Û=[û_{pq}] and is given by the following expression (3):

$${\hat{u}}_{p q} = \{ \begin{matrix}{u}_{11} & 1 \leq p = q \leq {2}^{n - j} \\ {u}_{12} & p = r , q = r + {2}^{n - j} , r ∈ \{ 1 , … , {2}^{n - j} \} \\ {u}_{21} & p = r + {2}^{n - j} , q = r , r ∈ \{ 1 , … , {2}^{n - j} \} \\ {u}_{22} & 1 + {2}^{n - j} \leq p = q \leq {2}^{n - j + 1} \\ 0 & otherwise\end{matrix} \qquad ( 3 )$$

where p and q represent the row and the column of a particular entry in Sⱼ, respectively.

For example, based on expressions (2) and (3), single-qubit gate U₁ (n=3, j=1) of quantum circuit 300 may be represented by unitary matrix S₁ using the following expression (4):

$${S}_{1} = [ \begin{matrix}{u}_{11} & 0 & 0 & 0 & {u}_{12} & 0 & 0 & 0 \\ 0 & {u}_{11} & 0 & 0 & 0 & {u}_{12} & 0 & 0 \\ 0 & 0 & {u}_{11} & 0 & 0 & 0 & {u}_{12} & 0 \\ 0 & 0 & 0 & {u}_{11} & 0 & 0 & 0 & {u}_{12} \\ {u}_{21} & 0 & 0 & 0 & {u}_{22} & 0 & 0 & 0 \\ 0 & {u}_{21} & 0 & 0 & 0 & {u}_{22} & 0 & 0 \\ 0 & 0 & {u}_{21} & 0 & 0 & 0 & {u}_{22} & 0 \\ 0 & 0 & 0 & {u}_{21} & 0 & 0 & 0 & {u}_{22}\end{matrix} ] \qquad ( 4 )$$

For another example, single-qubit gate U₄ (n=3, j=2) of quantum circuit 300 may be represented by unitary matrix S₂ using the following expression (5), which is obtained by expressions (2) and (3):

$${S}_{2} = [ \begin{matrix}{u}_{11} & 0 & {u}_{12} & 0 & 0 & 0 & 0 & 0 \\ 0 & {u}_{11} & 0 & {u}_{12} & 0 & 0 & 0 & 0 \\ {u}_{21} & 0 & {u}_{22} & 0 & 0 & 0 & 0 & 0 \\ 0 & {u}_{21} & 0 & {u}_{22} & 0 & 0 & 0 & 0 \\ 0 & 0 & 0 & 0 & {u}_{11} & 0 & {u}_{12} & 0 \\ 0 & 0 & 0 & 0 & 0 & {u}_{11} & 0 & {u}_{12} \\ 0 & 0 & 0 & 0 & {u}_{21} & 0 & {u}_{22} & 0 \\ 0 & 0 & 0 & 0 & 0 & {u}_{21} & 0 & {u}_{22}\end{matrix} ] \qquad ( 5 )$$

For a two-qubit control gate in an n-qubit system with the i-th qubit as the control qubit and the j-th qubit as the target qubit, the unitary matrix representing the two-qubit control gate may be expressed separately in two different scenarios. For example, the two different scenarios may be when i<j and i>j. When i<j, the two-qubit control gate may be expressed by the following expression (6):

$$C {U}_{i < j} = diag \{ {\underbrace{{I}_{{2}^{n - i}} , {\hat{U}}_{i < j} , {I}_{{2}^{n - i}} , {\hat{U}}_{i < j} , … , {I}_{{2}^{n - i}} , {\hat{U}}_{i < j}}}_{{2}^{i} blocks} \} \qquad ( 6 )$$

where CU_{i<j} has an order of 2ⁿ, I₂_{^{n−i}} denotes an identity matrix of order 2ⁿ⁻ⁱ, and

$${\hat{U}}_{i < j} = diag \{ {\underbrace{\hat{U} , ……… \hat{U}}}_{{2}^{j - i - 1} times} \} ,$$

which denotes a two-sparse matrix with Û similar to the structure described in expression (3). When i>j, the two-qubit control gate may be expressed by the following expression (7):

$$C {U}_{i > j} = diag \{ {\underbrace{{I}_{{2}^{n - i}} , {\hat{U}}_{i > j} , {I}_{{2}^{n - i}} , {\hat{U}}_{i > j} , … , {I}_{{2}^{n - i}} , {\hat{U}}_{i > j}}}_{{2}^{j} blocks} \} \qquad ( 7 )$$

where CU_{i>j} has an order of 2ⁿ, I₂_{^{n−i}} denotes an identity matrix of order 2ⁿ⁻ⁱ, and Û_{i>j} denotes a matrix of similar structure as described in more detail in Reference 1.

For example, two-qubit control gate U₈ (n=3, i=2, and j=3) of quantum circuit 300 falls under the scenario of i<j based on Qubit 2 being the control qubit so i=2 and Qubit 3 being the target Qubit so j=3 and n=3 because it is a 3 qubit system. Based on expression (6), U₈ may be represented by the following expression (8):

$${U}_{8} = diag \{ {I}_{{2}^{1}} , {\hat{U}}_{i < j} , {I}_{{2}^{1}} , {\hat{U}}_{i < j} \} \qquad ( 8 )$$

where U₈ has an order of 2³, and Û_{i<j} may be represented by the following expression (9):

$${\hat{U}}_{i < j} = [ \begin{matrix}{u}_{11} & {u}_{12} \\ {u}_{21} & {u}_{22}\end{matrix} ] \qquad ( 9 )$$

For another example, for a two-qubit control gate in a five-qubit system (not shown in FIG. 3) with n=5, i=2, and j=3, based on expression (6), the two-qubit control gate may be represented by the following expression (10):

$$C {U}_{i < j} = diag \{ {I}_{{2}^{3}} , {\hat{U}}_{i < j} , {I}_{{2}^{3}} , {\hat{U}}_{i < j} \} \qquad ( 10 )$$

where CU_{i<j} has an order of 32, and Û_{i<j} may be represented by the following expression (11):

$${\hat{U}}_{i < j} = [ \begin{matrix}{u}_{11} & 0 & 0 & 0 & {u}_{12} & 0 & 0 & 0 \\ 0 & {u}_{11} & 0 & 0 & 0 & {u}_{12} & 0 & 0 \\ 0 & 0 & {u}_{11} & 0 & 0 & 0 & {u}_{12} & 0 \\ 0 & 0 & 0 & {u}_{11} & 0 & 0 & 0 & {u}_{12} \\ {u}_{21} & 0 & 0 & 0 & {u}_{22} & 0 & 0 & 0 \\ 0 & {u}_{21} & 0 & 0 & 0 & {u}_{22} & 0 & 0 \\ 0 & 0 & {u}_{21} & 0 & 0 & 0 & {u}_{22} & 0 \\ 0 & 0 & 0 & {u}_{21} & 0 & 0 & 0 & {u}_{22}\end{matrix} ] \qquad ( 11 )$$

Modifications, additions, or omissions may be made to the quantum gates U₁ to U₈ without departing from the scope of the disclosure. For example, one or more gates may be added or removed from one of the qubits.

A neural network may typically include multiple layers organized in a sequential structure. Each layer includes a plurality of nodes, also referred to as neurons or units. The nodes in adjacent layers are interconnected by edges or connections, each associated with a weight parameter. Initially, the weight parameters are assigned initial values, which may be zero, randomly generated, or based on a predefined strategy. An input dataset is provided to the input layer (the first layer) of the neural network, and the data is propagated through the network using activation functions at each node. The final output is produced by the output layer (the last layer). To train the neural network, the output is compared against a set of desired objectives, referred to as the ground truth or target values, using a loss function that quantifies the difference between the predicted output and the target values. The loss function is then minimized by adjusting the weight parameters using optimization algorithms. This process, known as backpropagation, iteratively updates the weight parameters to improve the network's performance and achieve a configuration that may satisfy particular parameters.

To construct a neural network representation of a quantum circuit, the architecture of the neural network and the connectivity topology between adjacent layers may be defined. The architecture of the neural network includes the number of layers and the number of nodes in each layer. The connectivity topology between adjacent layers specifies how nodes in one layer are connected to nodes in the subsequent layer, as well as the associated weight parameters of the connections (edges).

In some embodiments, a linear neural network may be used to represent a quantum circuit. A linear neural network may have the same number of nodes across all layers. A linear neural network may also use linear activation functions. A linear neural network iteratively transforms an input through a sequence of simple linear transformations. Details regarding a recursive structure of a linear neural network and the effects of the network's hyperparameters, such as its initialization scheme, width, and depth, etc., are described in a paper The Principles of Deep Learning Theory, Roberts et al., Cambridge University Press Cambridge, MA, USA, 2022, incorporated herein by reference in its entirety.

In some embodiments, a neural network, such as a linear neural network, may be used to represent a parametrized quantum circuit. In these and other embodiments, for an n-qubit quantum circuit including k quantum gates, the neural network may be constructed with k+1 layers, with each layer containing 2ⁿ nodes. Each quantum gate may be represented by two adjacent layers in the neural network and the connections between the nodes in each layer of the two adjacent layers. Thus, a linear neural network with k+1 layers may represent k quantum gates. For example, the first quantum gate (k=1) may be represented by the first layer and the second layer and the connections between the first layer and the second layer, while the kth quantum gate may be presented by the kth layer and the (k+1)th layer (the last layer) and the connections between the kth layer and the (k+1)th layer.

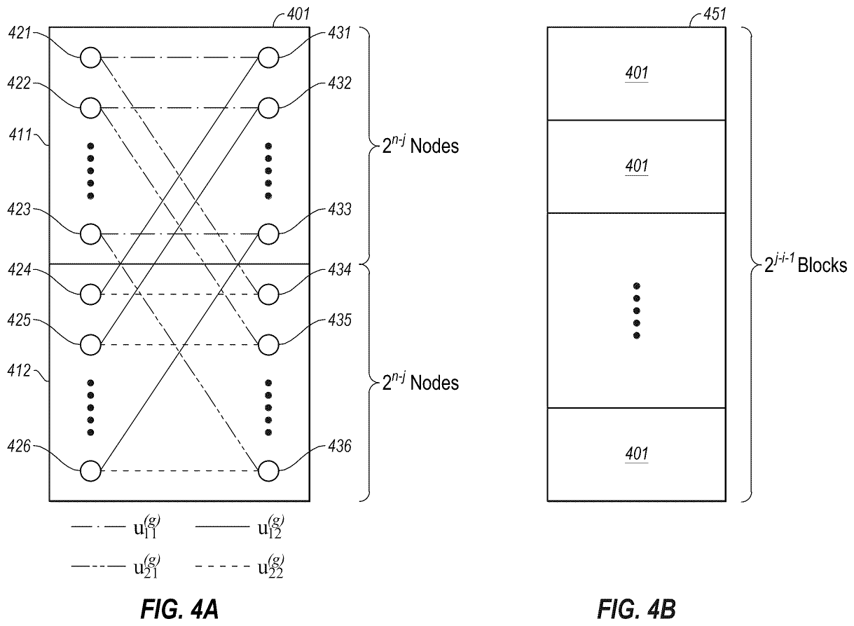

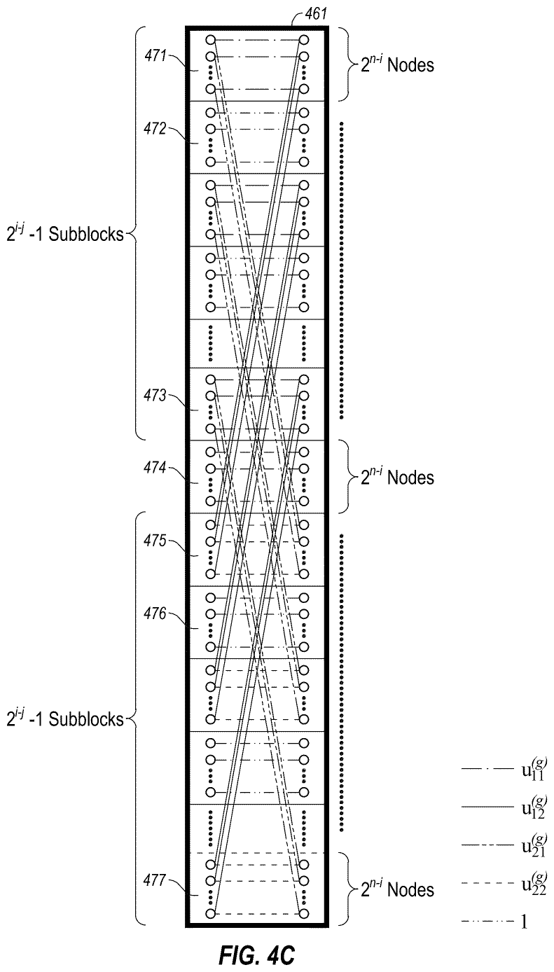

FIG. 4A illustrates a topological pattern in a neural network architecture, such as a linear neural network, used to represent a single-qubit gate according to one or more embodiments of the present disclosure. The single-qubit gate being represented may be applied to the j-th qubit in an n-qubit system. For simplicity, gate U₄ illustrated in FIG. 3 (n=3, j=1, k=3) is used as an example. However, the same topological pattern may be generalized to other single-qubit gates in a quantum circuit. Gate U₄ may be represented by the fourth and fifth layers of the neural network and the connections between them, with each layer containing 2ⁿ nodes. A portion of this representation is shown as block 401 in FIG. 4A.

Block 401 includes two columns of layers corresponding to the fourth layer (the “left layer”) and the fifth layer (the “right layer”) of the neural network. Each layer in block 401 contains 2^{n-j+1} nodes. Note that when j=1 (e.g., for gates U₁, U₂, or U₃ of FIG. 3), block 401 may contain 2ⁿ⁻¹⁺¹=2ⁿ nodes and therefore may represent the entire layer.

Block 401 is divided vertically into two subblocks, labeled subblocks 411 and 412. Each subblock contains 2^{n-j} nodes per layer. The nodes in each layer of each subblock are labeled sequentially based on their vertical positions, ranging from 1 to 2^{n-j}. For example, in the left layer of subblock 411, node 421 is labeled as 1, node 422 is labeled as 2, and node 423 is labeled as 2^{n-j}. In the right layer of subblock 411, node 431 is labeled as 1, node 432 is labeled as 2, and node 433 is labeled as 2^{n-j}. Likewise, in subblock 412, nodes 424 and 434 are labeled as 1, nodes 425 and 435 are labeled as 2, and nodes 426 and 436 are labeled as 2^{n-j}. Block 401 also forms a bipartite graph that includes the left layer and the right layer. The left layer includes all the nodes in the left layer, e.g., from the first node 421 to the last node 426. The right layer includes all the nodes in the right layer, e.g., from the first node 431 to the last node 436.

In some embodiments, one or more of the nodes in the left layer of block 401 may be connected to one or more nodes of the right layer of block 401. In these and other embodiments, each of the nodes in the left layer of block 401 may be connected to one or more nodes of the right layer of block 401. Alternately or additionally, each of the nodes in the right layer of block 401 may be connected to one or more nodes of the left layer of block 401. In these and other embodiments, each of the nodes of in the left layer of block 401 may be connected to two nodes of the right layer of block 401.

In some embodiments, connections between nodes in the left and right layers of block 401 may fall into two categories. In the first category, a first node in the left layer may connect to a second node in the right layer where the first node and the second node have the same vertical position in the block 401. The same vertical position in the block may be same number of nodes down from a top or the first node of the block 401. For example, node 421 in the left layer (labeled as 1) is connected to node 431 (also labeled as 1) in the right layer, and node 426 is connected to node 236 (both are labeled 2^{n-j}). Because these connections connect two nodes in the same vertical position, they are also referred to as “horizontal connections.” For horizontal connections in subblock 411, such as connections between nodes 421 and 431 or between nodes 423 and 433, the weight parameters may be denoted as

$${u}_{11}^{( g )} .$$

For horizontal connections in subblock 412, such as connections between nodes 426 and 436, the weight parameters may be denoted as

$${u}_{22}^{( g )} .$$

In some embodiments, each of the nodes in the left layer may have a horizontal connection with a node in the right layer.

In the second category, a first node in the left layer of one subblock may be connected to a second node in the right layer of the other subblock where the first node and the second node have the same vertical position in their respective subblocks. The same vertical position in a subblock may be same number of nodes down from a top or the first node of the subblock. The two nodes having the same vertical position in the same or different subblocks may be referred to as the “same-labeled” nodes in this disclosure. For example, node 421 in subblock 411 may be connected to the same-labeled node 434 in subblock 412, and node 423 in subblock 411 may be connected to node 436 in subblock 412. The weight parameters for these connections may be denoted as

$${u}_{21}^{( g )} .$$

Likewise, node 424 in subblock 412 may be connected to the same-labeled node 431 in subblock 411, and node 426 in subblock 412 may be connected to node 433 in subblock 411. The weight parameters for these connections may be denoted as

$${u}_{12}^{( g )} .$$

FIG. 4B illustrates a topological pattern in a neural network architecture used to represent a two-qubit control gate when i<j, according to one or more embodiments of the present disclosure. The two-qubit control gate being represented is in an n-qubit system with the i-th qubit as the control qubit and the j-th qubit as the target qubit and where i<j. For simplicity, gate U₈ illustrated in FIG. 3 (n=3, i=2, j=3, k=8) is used as an example. However, the same topological pattern may be generalized to other two-qubit control gates in a quantum circuit. Gate U₈ may be represented by the eighth and ninth layers of the neural network and the connections between them, with each layer containing 2ⁿ nodes.

As previously discussed, weight matrix CU_{i<j} of expression (6) may be used to represent gate U₈. There are 2ⁱ blocks in CU_{i<j}, and each block is denoted by Bₗ, where 1≤l≤2ⁱ. Based on expression (6), when l is odd, Bₗ denotes the identity matrix I₂_{^{n−i}}. Thus, the corresponding nodes in the eighth and ninth layers are connected horizontally with weights equal to 1. When l is even, Bₗ denotes Û_{i<j}, which is represented by block 451. Block 451 includes 2^{j-i-1} subblocks, with each subblock corresponding to block 401 as shown in FIG. 4A. In FIG. 4B, there are no connections between nodes across different subblocks.

FIG. 4C illustrates a topological pattern in a neural network architecture used to represent a two-qubit control gate when i>j, according to one or more embodiments of the present disclosure. The two-qubit control gate being represented is in an n-qubit system with the i-th qubit as the control qubit and the j-th qubit as the target qubit, where i>j. For simplicity, gate U₆ illustrated in FIG. 3 (n=3, i=3, j=2, k=6) is used as an example. However, the same topological pattern may be generalized to other two-qubit control gates in a quantum circuit. Gate U₆ may be represented by the sixth and seventh layers of the neural network and the connections between them, with each layer containing 2ⁿ nodes.

As previously discussed, weight matrix CU_{i>j} of expression (7) may be used to represent U₆. There are 2^{j} blocks in CU_{i>j}, each block is denoted by Bₗ, where 1≤l≤2^{j}. When l is odd, Bₗ denotes the identity matrix I₂_{^{n−i}}. Thus, the corresponding nodes in the sixth and seventh layers may be connected horizontally. The weight parameters for these connections may be 1. When l is even, Bₗ denotes Û_{i>j}, which is represented by block 461. Block 461 includes two columns of layers corresponding to the sixth layer (the “left layer”) and the seventh layer (the “right layer”) of the neural network. Block 461 has several subblocks, such as subblocks 471-477. These subblocks are divided into three groups. The first group may include 2^{i-j}−1 subblocks including subblocks 471, 472 and continuing to the last subblock in the group denoted as 473. The second group may include one subblock 474. The third group may include another 2^{i-j}−1 subblocks including subblocks 475, 476 and continuing to the last subblock denoted as 477. Each subblock in the first and third group may also be associated with a “vertical position” within that group. The vertical position of a subblock within a group may be the number of subblocks down from a top or the first subblock of the group. For example, in the first group, subblock 471 is associated with position 1, subblock 472 is associated with position 2, and subblock 473 is associated with position 2^{i-j}−1, and so on. Likewise, in the third group, subblocks 475, 476, and 477 are associated with positions 1, 2, and 2^{i-j}−1, respectively. The two subblocks associated with the same vertical position in the first and third group may be referred to as the “same-positioned” subblocks in this disclosure. For example, subblocks 471 and 475, and subblocks 473 and 477, are “same-positioned” subblocks in the first and third group.

Each subblock in block 461 has 2ⁿ⁻ⁱ nodes and is denoted by Bₗₛ, where 1≤s≤2^{i-j+1}−1. When s is even, Bₗₛ represents an identity matrix which corresponds to subblocks of 2ⁿ⁻ⁱ nodes with horizontal connections, such as subblocks 472, 474, and 475. The weight parameters for these connections are 1.

When s is odd, Bₗₛ represents other non-identity matrix subblocks such as subblocks 471, 473, 475, and 477. Connections between nodes in the left and right layers of these subblocks may also fall into two categories, which is similar to the topological patterns described in the case of i<j in the first category of connections. Every node in the left layer of these subblocks may be connected horizontally to the same-labeled nodes in the right layer of the same subblock. The weight parameters for these connections are

$${u}_{11}^{( g )}$$

if the subblocks are in the first group and

$${u}_{22}^{( g )}$$

if the subblocks are in the third group.

In the second category of connections, every node in the left layer of the subblocks in the first group may be connected to the same-labeled nodes in the right layer of the same-positioned subblocks in the third group. The weight parameters for these connections are

$${u}_{21}^{( g )} .$$

These connections are indicated, e.g., between nodes in the left layer of subblock 471 and nodes in the right layer of subblock 475. In addition, every node in the left layer of the subblocks in the third group may be connected to the same-labeled nodes in the right layer of the same-positioned subblocks in the first group. The weight parameters for these connections are

$${u}_{12}^{( g )} .$$

These connections are indicated, e.g., between nodes in the left layer of subblock 475 and nodes in the right layer of subblock 471.

FIGS. 5A and 5B illustrate an example of using a linear neural network to represent a given quantum circuit according to one or more embodiments of the present disclosure. FIG. 5A illustrates an example quantum circuit 500 according to one or more embodiments of the present disclosure. The quantum circuit 500 may be an example of the quantum circuit of FIG. 1. The quantum circuit 500 is a 4-qubit system including four qubits, denoted as qubits 1-4. Gates U₁-U₁₂ are single-qubit gates, while gates U₁₃-U₁₆ are two-qubit control gates.

FIG. 5B illustrates an example linear neural network 510 configured to represent the quantum circuit 500 according to one or more embodiments of the present disclosure. Although quantum circuit 500 includes both single-qubit gates and two-qubit control gates, for simplicity and illustrative purposes, the neural network 510 is shown to represent only the four two-qubit control gates U₁₃-U₁₆. Thus, the neural network 510 represents a quantum circuit where n=4 and k=4. Based on the disclosed embodiments, neural network 510 includes k+1=5 layers, labeled as layers 521-525, with each layer containing 2⁴=16 nodes. Each of the two-qubit control gates U₁₃-U₁₆ is represented by connections between two adjacent layers, referred to as interlayers 531-534, such that interlayer 531 corresponds to gate U₁₃, interlayer 532 corresponds to gate U₁₄, interlayer 533 corresponds to gate U₁₅, and interlayer 534 corresponds to gate U₁₆.

For gate U₁₃, where i=1 and j=2, this is the case of i<j. According to the one or more embodiments previously discussed, there are 2¹=2 blocks in interlayer 531, denoted by blocks B₁-B₂. The first block B₁ is the identity matrix I₂_{^{n−i}}=I₈, corresponding to connections of weights 1 between nodes 1-8 of layers 531 and 532. The second block B₂ is represented by block 451 of FIG. 4B, which includes 2^{j-i-1}=2⁰=1 subblock. Thus, B₂ may be represented by the topological patterns depicted in block 401 of FIG. 4A. As shown in FIG. 4A, block 401 has 2^{n-j+1}=2³=8 nodes in each layer, corresponding to nodes 9-16 of layers 531 and 532. The first category of connections may be depicted by horizontal connections between nodes 9-12 of both layers (at weights u₁₁) and between nodes 13-16 of both layers (at weights u₂₂). The second category of connections may be depicted by connections from nodes 9-12 of layer 531 to nodes 13-16 of layer 532 (at weights u₂₁) and connections from nodes 13-16 of layer 531 to nodes 9-12 of layer 532 (at weights u₁₂).

For gate U₁₄, where i=2 and j=3, this is also the case of i<j. Accordingly, there are 2ⁱ=4 blocks in interlayer 532, denoted by Bₗ, where 1≤l≤4, representing blocks B₁-B₄. The first and third blocks B₁ and B₃ (when l is odd) are the identity matrices I₂_{^{n−i}}=I₄, corresponding to connections of weights 1 between nodes 1-4 and 9-12 of layers 532 and 533. The second and fourth blocks B₂ and B₄ (when l is even) may be represented by block 451 of FIG. 4B, which includes 2^{j-i-1}=2⁰=1 subblock. Thus, B₂ and B₄ may be represented by the topological patterns depicted in block 401 of FIG. 4A. In this case, block 401 has 2^{n-j+1}=2²=4 nodes in each layer, corresponding to nodes 5-8 of layers 532 and 533 for B₂, and nodes 9-12 of layers 532 and 533 for B₄. Similarly, the connections between these nodes follow the same patterns depicted in block 401. For example, in B₂, the horizontal connections are between nodes 5-6 of both layers (at weights u₁₁) and between nodes 7-8 of both layers (at weights u₂₂). The second category of connections include connections from nodes 5-6 of layer 532 to nodes 7-8 of layer 533 (at weights u₂₁) and connections from nodes 7-8 of layer 532 to nodes 5-6 of layer 533 (at weights u₁₂).

For gate U₁₅, as it is also the case of i<j, the connections in interlayer 533 may be similarly constructed based on the topological patterns of interlayers 531 and 532. For gate U₁₆, where i=4 and j=1, this is the case of i>j. Accordingly, the connections in interlayer 534 may be structured based on the topological patterns depicted in block 461 of FIG. 4C.

It should be noted that while the quantum circuit 500 includes only single-qubit gates and two-qubit control gates, it is provided for illustrative purposes only. A quantum circuit may also include one or more multi-qubit gates that operate on more than two qubits. However, multi-qubit gates may be mathematically expressed by single-qubit gates and/or two-qubit control gates. Accordingly, the quantum circuit representation model described in this disclosure may serve as a universal model for quantum computing. Thus, the quantum circuit representation model described in this disclosure may represent any quantum circuit irrespective of the types of quantum gates included in the quantum circuit.

Modifications, additions, or omissions may be made to the quantum circuit 500 and the linear neural network 510 without departing from the scope of the disclosure. For example, one or more connections may be added or removed in one of the interlayers.

FIG. 6 is a flowchart of an example method 600 of training quantum computing systems using linear neural network representation of quantum circuits, according to one or more embodiments of the present disclosure. The method 600 may be performed by any suitable system, apparatus, or device. For example, the quantum computing system 100, the quantum hardware 108, and/or the processing system 112 may perform one or more of the operations associated with the method 600. Although illustrated with discrete blocks, the steps and operations associated with one or more of the blocks of the method 600 may be divided into additional blocks, combined into fewer blocks, or eliminated, depending on the particular implementation.

The method 600 may begin at block 602, where a quantum circuit may be generated based on a quantum application. The quantum application may be developed to solve a real-world problem, such as an optimization problem in financial portfolio management or logistics, among others. The quantum application may be developed using quantum algorithms, such as the Quantum Approximate Optimization Algorithm (QAOA), to find approximate solutions to the optimization problems. To generate a quantum circuit such as the quantum circuits 110, 300, and 500 illustrated in FIGS. 1, 3, and 5A, respectively, a quantum programming framework may be used to define the number of qubits, the types and the numbers of quantum gates, and the circuit structure. The quantum application may then be encoded into an initial quantum circuit by mapping the classical data of the problem (e.g., risk factors) into quantum states. This may be performed through amplitude encoding or basis encoding. The quantum circuit may then be constructed by selecting the appropriate quantum gates that implement the quantum algorithms and perform the necessary transformations on the qubits. The quantum circuit may be generated based on the quantum application or hardware layout of the quantum application.

At block 604, a neural network representation of the quantum circuit may be developed. Based on the configuration of the quantum circuit generated in block 602, including the number of qubits, the type of quantum gates (single-qubit gate or two-qubit control gate), and the locations of the quantum gates, etc., the processing system 112 may develop a neural network representation of the quantum gates using the embodiments presented in this disclosure. A quantum gate, whether single-qubit or two-qubit, may be represented by the expression (1), where u₁₁, u₁₂, u₂₁, and u₂₂ represent parameters of a single-qubit quantum gate. For example, a neural network representation for a single-qubit gate may be illustrated in FIG. 4A, two-qubit control gate where i<j may be illustrated in FIG. 4B, and two-qubit control gate where i>j may be illustrated in FIG. 4C. Based on these representations, a neural network such as neural network 510 may be constructed, with layers corresponding to the number of quantum gates in the quantum circuit, and the number of nodes in layers corresponding to the number of qubits. The connections between nodes may be defined by the neural network representations of quantum gates, associated with weight parameters such as u₁₁, u₁₂, u₂₁, u₂₂, or 1 representing the parameters of the quantum gates, as illustrated in FIG. 5B.

At block 606, the neural network that represents the quantum circuit may be trained and evaluated using machine learning techniques. The weight parameters, such as u₁₁, u₁₂, u₂₁, u₂₂, of the neural network may be initialized with initial values, which may be zero or randomly generated, and these parameters may be optimized during training. The training of neural network may be performed by the processing system 112. To train the neural network, a set of training data representing input-output pairs of the quantum circuit may be used. The input data may correspond to classical data that is encoded into quantum states, and the output data may correspond to the results of the quantum circuit after the application of quantum gates. The neural network may be trained using machine learning techniques, such as backpropagation and gradient descent, where the loss function quantifies the difference between the predicted output of the neural network and the actual quantum circuit output.

During the training process, the parameters of the neural network may be adjusted iteratively to minimize the loss, which improves the accuracy of the network's representation of the quantum circuit. Evaluation of the neural network's performance may be conducted by testing the neural network on a separate validation dataset that was not seen during training. This validation dataset may include data from the real-world problem and may be used to determine whether the neural network representation is capable of solving the real-world problem.

At block 608, the trained neural network representation may be converted back to the quantum circuit. The trained neural network from block 606, which includes the trained weight parameters of quantum gates through machine learning techniques, may be used to construct a new quantum circuit or adjust the existing quantum circuit 110. If the output of the trained neural network from block 606 indicates that the real-world problem may be solved, the neural network representation may be converted back to the quantum circuit 110 in the quantum computing system 100 for further operation and training. To convert the neural network representation into a quantum circuit, the learned weight parameters from the neural network, such as u₁₁, u₁₂, u₂₁, and u₂₂, may be mapped to the parameters of the quantum gates in the quantum circuit 110, which may involve rotations, phase shifts, or other gate-specific transformations. The quantum circuit may be constructed by sequentially applying the quantum gates in an appropriate order based on the learned parameters from the neural network. If the output of the trained neural network indicates that the real-world problem may not be solved, a new quantum circuit may be generated at block 602, and the process may be repeated to identify a quantum circuit that may be suitable for solving the real-world problem. This process ensures the discovery of an appropriate quantum circuit without unnecessary expenditure of quantum resources.

Modifications, additions, or omissions may be made to the method 600 without departing from the scope of the disclosure. Further, the method 600 may include any number of other elements or may be implemented within other systems or contexts than those described.

FIG. 7 is a flowchart of an example method 700 of training quantum computing systems using linear neural network representation of quantum circuits, according to one or more embodiments of the present disclosure. The method 700 may be performed by any suitable system, apparatus, or device. For example, the quantum computing system 100, the quantum hardware 108, and/or the processing system 112 may perform one or more of the operations associated with the method 700. Although illustrated with discrete blocks, the steps and operations associated with one or more of the blocks of the method 700 may be divided into additional blocks, combined into fewer blocks, or eliminated, depending on the particular implementation.

The method 700 provides a specific example of generating a probability distribution for a quantum application to solve a real-world problem. Quantum circuits and algorithms may be used to estimate the output of the quantum application, which is often expressed as a probability distribution. Appropriate quantum circuits may be selected to generate a desired probability distribution.

The method 700 may begin at block 702, where an initial distribution and a target distribution of a quantum application may be obtained. The initial distribution represents the initial state of a quantum circuit, which may be described by a set of quantum gates that encodes the probability distribution of a set of input data of a real-world problem, such as the probability distribution of values of a particular stock. The target distribution represents the desired probability distribution of a given quantum application, which may be defined by the real-world problem to be solved, such as an optimization problem. The target distribution may be obtained from empirical data and provides the objective for the quantum application to achieve, such as a desired holding percentage of a particular stock in a financial portfolio.

At block 704, a quantum circuit is generated based on the quantum application and a neural network representation of the quantum circuit may be developed. Block 704 may be performed by the processing system 112 and may align with the process described in blocks 602 and 604 of FIG. 6. The quantum application may be developed using quantum algorithms. The quantum circuits, such as the quantum circuits 110, 300, and 500 illustrated in FIGS. 1, 3, and 5A, may be generated based on the quantum algorithms by selecting and arranging quantum gates in an appropriate sequence. A neural network may then be generated to approximate the behavior of the quantum circuit. As previously described, the layers of the neural network correspond to the quantum gates. The network's parameters are initialized to reflect the structure of the quantum circuit. In one embodiment, the neural network representation may be implemented using the neural network 510 illustrated in FIG. 5B.

At block 706, a determination may be made as to whether the neural network representation may produce the target distribution. Block 706 may be performed by the processing system 112. The input data with initial distribution may be applied to the neural network representing the quantum circuit. The neural network then processes the input data, and the probability distribution from the output data may be obtained. This output distribution is compared to the target distribution, which defines the desired outcome for the quantum application. In some embodiments, the determination may involve computing the upper bound of the output probability distribution, which may serve as a metric to assess how close the output distribution is to the target distribution. The upper bound may be computed as the maximum achievable similarity or closeness between the output distribution and the target distribution, which may be formalized using statistical measures such as the total variation distance. Additionally or alternatively, the determination may also involve computing the loss function of the neural network representation. The loss function quantifies the difference between the output distribution and the target distribution. The loss function may be calculated using methods such as Kullback-Leibler (KL) divergence or mean squared error (MSE), which quantify the difference between the output and target distributions. Numerical optimization techniques, such as gradient descent, may be applied to minimize the loss function.

The calculated upper bound or the loss function exceeding a threshold, may indicate that the neural network representation may not produce the target distribution. The threshold may be determined based on the specific quantum application and the acceptable accuracy level. For example, the threshold may be determined by analyzing the performance of the neural network across a set of training or test data to identify a point where the output distribution sufficiently approximates the target distribution. Alternatively, the threshold may be determined based on the expected error tolerance of the quantum circuit or from statistical bounds associated with the target distribution. If the threshold is exceeded, the method 700 then returns to block 704, where a new quantum circuit may be generated that may result in reducing the upper bound of the output distribution or the loss function, and a corresponding neural network representation may be developed according to the process described in block 704. For example, new quantum gates may be added, or parameters in existing quantum gates may be changed or removed in the previous quantum circuit 110. On the other hand, if the upper bound or the loss function is within the threshold, indicating that the neural network representation may produce the target distribution, the method 700 advances to block 708.

At block 708, the neural network capable of producing the target distribution may be trained using learning techniques. Supervised learning may be employed, where the network may be trained using labeled input-output pairs, and the loss function may be minimized to align the output distribution with the target distribution. Unsupervised learning techniques, such as variational autoencoders, may also be used to uncover underlying patterns in the data without requiring labeled outputs. These training techniques may refine the parameters of the neural network, such as weight parameters u₁₁, u₁₂, u₂₁, and u₂₂, to align the output distribution with the target distribution. Since the output of a quantum process is inherently probabilistic, sufficient sampling is important to ensure the process generates the desired outcome. For a quantum circuit with n qubits, at least 2ⁿ data points may need to be sampled to define the target distribution. For example, in the case of the quantum circuit 500 where n=4, a minimum of 16 data points may be sampled. In some embodiments, multiple samples, each containing at least 2ⁿ sampled data points, may be performed to train, and test the neural network to ensure that the quantum circuit representation produces the desired outcome.

At block 710, parameters of the quantum circuit may be generated as the output of the training. The output of the trained neural network may include learned parameters, such as weight parameters u₁₁, u₁₂, u₂₁, and u₂₂, which may be mapped to the parameters of the quantum gates in the quantum circuit 110. Based on these parameters, a new quantum circuit may be constructed or the existing quantum circuit 110 may be adjusted in the quantum computing system 100 for further operation and testing.

Based on the above, the method 700 is not restricted to any specific probability distribution. It may be applied to quantum applications involving a wide range of distributions, such as normal or copula distributions. Therefore, the method 700 is a more generalized solution for solving real-world problems.

Modifications, additions, or omissions may be made to the method 700 without departing from the scope of the disclosure. Further, the method 700 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
obtaining a configuration of a quantum circuit comprising n qubits and k quantum gates, the k quantum gates comprising at least one of a single-qubit gate or a two-qubit control gate;
constructing a neural network representing the quantum circuit, the neural network comprises k+1 layers that comprises of k pairs of adjacent layers, each pair of the adjacent layers corresponding to one of the k quantum gates;
connecting one or more nodes in each pair of the adjacent layers based on a representation of a corresponding quantum gate of the k quantum gates;
training the neural network using machine learning techniques to obtain an output; and
applying the output to the quantum circuit.

2. The method of claim 1, wherein each layer of the k+1 layers comprises 2ⁿ nodes and the single-qubit gate is on a j-th qubit of the quantum circuit, wherein the pair of the adjacent layers corresponding to the single-qubit gate comprises a first connection block, the first connection block comprising:
a first partition comprising 2^{n-j+1} nodes being part of a first layer in the pair of the adjacent layers;
a second partition comprising 2^{n-j+1} nodes being part of a second layer in the pair of the adjacent layers, the second layer being a subsequent layer of the first layer;
a first subblock comprising a first group of 2^{n-j} nodes being a first half of the 2^{n-j+1} nodes in the first partition, and a group of second 2^{n-j} nodes being a first half the 2^{n-j+1} nodes in the second partition; and
a second subblock comprising a third group of 2^{n-j} nodes being a second half of the 2^{n-j+1} nodes in the first partition, and a fourth group of 2^{n-j} nodes being a second half of the 2^{n-j+1} nodes in the second partition,
wherein, nodes in each of the first, the second, the third, and the fourth groups of 2^{n-j} nodes are sequentially labeled based on vertical positions of the nodes.

3. The method of claim 2, further comprising:
connecting nodes in the first group of 2^{n-j} nodes to the same-labeled nodes in the second and the fourth group of 2^{n-j} nodes, and
connecting nodes in the third group of 2^{n-j} nodes to the same-labeled nodes in second and the fourth group of 2^{n-j} nodes.

4. The method of claim 2, wherein a target qubit of the two-qubit control gate is on a j-th qubit and a control qubit of the two-qubit control gate is on an i-th qubit, where i<j, wherein the pair of the adjacent layers corresponding to the two-qubit control gate comprises a second connection block, the second connection block comprising:
2ⁱ⁻¹ block pairs, each block pair comprising an identity matrix with an order of 2ⁿ⁻ⁱ and a Û_{i<j} block, wherein the Û_{i<j} block comprises the first connection block repeated in 2^{j-i-1} times.

5. The method of claim 3, wherein the single-qubit gate is represented by a symbolic unitary matrix
$$U = [ \begin{matrix}{u}_{11} & {u}_{12} \\ {u}_{21} & {u}_{22}\end{matrix} ] ,$$
the method further comprising:
applying u₁₁ as weight parameters when connecting the nodes in the first group of 2^{n-j} nodes to the same-labeled nodes in the second group of 2^{n-j} nodes;
applying u₂₂ as weight parameters when connecting the nodes in the third group of 2^{n-j} nodes to the same-labeled nodes in the fourth group of 2^{n-j} nodes;
applying u₁₂ as weight parameters when connecting the nodes in the third group of 2^{n-j} nodes to the same-labeled nodes in the second group of 2^{n-j} nodes; and
applying u₂₁ as weight parameters when connecting the nodes in the first group of 2^{n-j} nodes to the same-labeled nodes in the fourth group of 2^{n-j} nodes.

6. The method of claim 1, wherein the quantum circuit is generated based on a quantum application.

7. The method of claim 6, further comprising:
obtaining an initial distribution and a target distribution of the quantum application;
determining whether the neural network representing the quantum circuit may produce the target distribution; and
training the neural network in accordance with the determination that the neural network may produce the target distribution.

8. The method of claim 7, wherein determining whether the neural network representing the quantum circuit may produce the target distribution comprises:
computing an upper bound of an output probability distribution of the neural network; and
determining the neural network may produce the target distribution when the upper bound is within a threshold.

9. The method of claim 7, further comprising generating parameters of the quantum circuit as output.

10. The method of claim 1, wherein output of the trained neural network is learned parameters of the neural network.

11. A system comprising:
a quantum computing system comprising:
quantum hardware comprising a quantum circuit, and
a processing system configured to:
obtain a configuration of a quantum circuit comprising n qubits and k quantum gates, the k quantum gates comprising at least one of a single-qubit gate or a two-qubit control gate;
construct a neural network representing the quantum circuit, the neural network comprises k+1 layers that comprises of k pairs of adjacent layers, each pair of the adjacent layers corresponding to one of the k quantum gates;
connect one or more nodes in each pair of the adjacent layers based on a representation of a corresponding quantum gate of the k quantum gates;
train the neural network using machine learning techniques to obtain an output; and
apply the output to the quantum circuit.

12. The system of claim 11, wherein each layer of the k+1 layers comprises 2ⁿ nodes and the single-qubit gate is on a j-th qubit of the quantum circuit, wherein the pair of the adjacent layers corresponding to the single-qubit gate comprises a first connection block, the first connection block comprising:
a first partition comprising 2^{n-j+1} nodes being part of a first layer in the pair of the adjacent layers;
a second partition comprising 2^{n-j+1} nodes being part of a second layer in the pair of the adjacent layers, the second layer being a subsequent layer of the first layer;
a first subblock comprising a first group of 2^{n-j} nodes being a first half of the 2^{n-j+1} nodes in the first partition, and a group of second 2^{n-j} nodes being a first half the 2^{n-j+1} nodes in the second partition; and
a second subblock comprising a third group of 2^{n-j} nodes being a second half of the 2^{n-j+1} nodes in the first partition, and a fourth group of 2^{n-j} nodes being a second half of the 2^{n-j+1} nodes in the second partition,
wherein, nodes in each of the first, the second, the third, and the fourth groups of 2^{n-j} nodes are sequentially labeled based on vertical positions of the nodes.

13. The system of claim 12, wherein the processing system is further configured to:
connect nodes in the first group of 2^{n-j} nodes to the same-labeled nodes in the second and the fourth group of 2^{n-j} nodes, and
connect nodes in the third group of 2^{n-j} nodes to the same-labeled nodes in second and the fourth group of 2^{n-j} nodes.

14. The system of claim 12, wherein a target qubit of the two-qubit control gate is on a j-th qubit and a control qubit of the two-qubit control gate is on an i-th qubit, where i<j, wherein the pair of the adjacent layers corresponding to the two-qubit control gate comprises a second connection block, the second connection block comprising:
2ⁱ⁻¹ block pairs, each block pair comprising an identity matrix with an order of 2ⁿ⁻ⁱ and a Û_{i<j} block, wherein the Û_{i<j} block comprises the first connection block repeated in 2^{j-i-1} times.

15. The system of claim 13, wherein the single-qubit gate is represented by a symbolic unitary matrix
$$U = [ \begin{matrix}{u}_{11} & {u}_{12} \\ {u}_{21} & {u}_{22}\end{matrix} ] ,$$
and wherein the processing system is further configured to:
apply u₁₁ as weight parameters when connecting the nodes in the first group of 2^{n-j} nodes to the same-labeled nodes in the second group of 2^{n-j} nodes;
apply u₂₂ as weight parameters when connecting the nodes in the third group of 2^{n-j} nodes to the same-labeled nodes in the fourth group of 2^{n-j} nodes;
apply u₁₂ as weight parameters when connecting the nodes in the third group of 2^{n-j} nodes to the same-labeled nodes in the second group of 2^{n-j} nodes; and
apply u₂₁ as weight parameters when connecting the nodes in the first group of 2^{n-j} nodes to the same-labeled nodes in the fourth group of 2^{n-j} nodes.

16. The system of claim 11, wherein the quantum circuit is generated based on a quantum application.

17. The system of claim 16, wherein the processing system is further configured to:
obtain an initial distribution and a target distribution of the quantum application;
determine whether the neural network representing the quantum circuit may produce the target distribution; and
train the neural network in accordance with the determination that the neural network may produce the target distribution.

18. The system of claim 17, wherein determining whether the neural network representing the quantum circuit may produce the target distribution comprises:
computing an upper bound of an output probability distribution of the neural network; and
determining the neural network may produce the target distribution when the upper bound is within a threshold.

19. The system of claim 17, wherein the processing system is further configured to generate parameters of the quantum circuit as output.

20. A non-transitory computer readable media configured to store instructions that when executed by a system perform operations comprising:
obtaining a configuration of a quantum circuit comprising n qubits and k quantum gates, the k quantum gates comprising at least one of a single-qubit gate or a two-qubit control gate;
constructing a neural network representing the quantum circuit, the neural network comprises k+1 layers that comprises of k pairs of adjacent layers, each pair of the adjacent layers corresponding to one of the k quantum gates;
connecting one or more nodes in each pair of the adjacent layers based on a representation of a corresponding quantum gate of the k quantum gates;
training the neural network using machine learning techniques to obtain an output; and
applying the output to the quantum circuit.
